(19) United States
(12) Patent Application Publication
(10) Pub. No.: US 2017/0005310 A1
(43) Pub. Date: Jan. 5, 2017

(54) Separator for an Electrochemical Cell, Electrochemical Cell Comprising the Separator, Battery Containing at Least Two Electrochemical Cells, Mobile Consumer Devices, and Motor Vehicle Comprising the Battery

(71) Applicant: Bayerische Motoren Werke Aktiengesellschaft, Muenchen (DE)

(72) Inventors: Hideki OGIHARA, Haimhausen (DE); Nikolaos TSIOUVARAS, Muenchen (DE); Thomas WOEHRLE, Muenchen (DE)

(21) Appl. No.: 15/265,884

(22) Filed: Sep. 15, 2016

Related U.S. Application Data
(63) Continuation of application No. PCT/EP2015/053100, filed on Feb. 13, 2015.

(30) Foreign Application Priority Data
Mar. 20, 2014 (DE) 10 2014 205 234.3

(51) Int. Cl. H01M 2/16; H01M 4/48; H01M 10/0525

(52) U.S. Cl. CPC H01M 2/1626; H01M 2/162; H01M 10/0525; H01M 4/48; H01M 2220/20; H01M 2220/30

(57) ABSTRACT

A separator is provided for an electrochemical cell. The separator includes a nonwoven fabric having at least a first fiber and a second fiber. The first fiber is a biopolymer or is produced from this biopolymer. The second fiber is a plastic with a surface tension of at least 30 mN/m, preferably at least 36 mN/m, or is produced from this plastic. A separator of this kind is more cost-effective than conventional separators but, at the same time, can be effectively wetted by polar electrolytic solutions.

### CROSS REFERENCE TO RELATED APPLICATIONS

This application is a continuation of PCT International Application No. PCT/EP2015/053100, filed Feb. 13, 2015, which claims priority under 35 U.S.C. §119 from German Patent Application No. 10 2014 205 234.3, filed Mar. 20, 2014, the entire disclosures of which are herein expressly incorporated by reference.

### BACKGROUND AND SUMMARY OF THE INVENTION

The invention relates to a separator for an electrochemical cell, an electrochemical cell including the separator, a battery containing at least two electrochemical cells, mobile consumer devices and a motor vehicle including the battery

Galvanic cells, for example batteries, or rechargeable accumulators, are frequently used as energy storage devices in numerous applications, for example batteries in motor vehicles, or as energy storage devices in electrical cars or mobile electronic devices. These galvanic cells include an electrolyte arranged within or between two different electrodes, the anode and cathode, with storage of energy on an electrochemical basis by conversion of chemical to electrical energy. The medium between the two electrodes has to fulfill at least two functions. One function is to store and accommodate the electrolyte and, simultaneously, to assure ionic conductivity within the electrodes and between the anode and cathode. The further function of the separator is to electrically insulate the two electrodes from one another, in order to avoid short circuits.

The materials used as separators, which are both permeable to the ions of the electrolyte solution and electrically insulate the electrodes from one another, are polymer membranes which may consist of polyethylene or crystalline polyolefin. These separators are inexpensive on the one hand, but on the other hand have only weak thermal and mechanical stability, in that they are deformed above 90° and melting of the polymer membrane already sets in above 130°. More particularly, polymer membranes based on polyethylene and polypropylene do not have sufficient puncture resistance. The consequence of this is that, in the case of anodes consisting of lithium metal, where lithium is deposited in the form of dendrites, the separator can be punctured by these dendrites, causing an internal short circuit. Therefore, lithium anodes, even though they are a preferred anode material on the basis of the basic construction of a lithium ion battery, are not used together with these separators.

Separators based on polyethylene or polypropylene additionally have only inadequate wetting properties for the nonaqueous polar electrolyte solutions, which further complicates their use for galvanic cells.

Additionally, known are separators that are produced from polyimides (commercially available under the Energain® brand name from DuPont). Separators of this kind are more mechanically and thermally stable, but are more expensive.

It is an object of the present invention to provide a separator associated with fewer disadvantages than the conventional separators. Such an object is achieved by way of a separator according to embodiments of the invention. Advantageous developments of the separator and a galvanic cell comprising the separator, a battery in which the galvanic cells are connected, and a motor vehicle comprising the battery are described herein.

The invention provides a separator for a galvanic cell, comprising:

a nonwoven fabric having at least one nonwoven fabric layer, having at least one first and one second fiber,

wherein the first fiber comprises or has been manufactured from a biopolymer, and

the second fiber comprises or has been manufactured from a synthetic polymer having a surface tension of at least 30 mN/m, preferably at least 36 mN/m.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a schematic diagram of a lithium ion accumulator having an anode and an opposite cathode in accordance with an embodiment of the present invention.

### DETAILED DESCRIPTION OF THE PREFERRED EMBODIMENTS

A nonwoven fabric is provided, which is a material composed of aggregated fibers bonded to one another by fiber-endogenous adhesion, for example by fusion under pressure. The various fibers in a nonwoven material are positioned in a statistical distribution. Nonwoven fibers can be produced, for example, by a spinning and nonwoven formation process, and also by melting and dry spinning processes as well as wet spinning processes.

In the nonwoven fabric of the invention, a first fiber comprising or manufactured from a biopolymer is used. Biopolymers are naturally occurring polymers synthesized by cells, and polymers which can be formed by derivatization from the biopolymers. The biopolymers are polar polymers having high surface tensions.

For the production of the nonwoven material of the invention, a second fiber is additionally used, comprising or even manufactured from a polar synthetic polymer having a surface tension of at least 30 mN/m, preferably at least 36 mN/m. Synthetic polymers, by contrast with biopolymers, are understood to mean synthetically produced polymers that therefore do not occur in nature. Because of their good polarity and high surface tensions, these polymers are of good suitability for being wetted by the polar nonaqueous electrolyte solutions of the galvanic cells. The synthetic polymers for the second fibers have high surface tensions of at least 30 mN/m, which are thus higher than the surface tensions of polyolefinic polymers, for example polyethylene (PE) or polypropylene (PP). The surface tension of PE is between 33 and 35 mN/m, that of polytetrafluoroethylene 19.1 mN/m, and the surface tension of PP is about 29 mN/m.

The surface tension of the fibers, which is a measure of the polarity of the fibers, can be measured, for example, by producing rectangular sheets from the synthetic polymers of the fibers and determining the surface tension thereof by German industrial standard DIN ISO 8296 with appropriate test inks.

Because of the inventive combination of the first fibers with the biopolymer and the second fibers with the polar synthetic polymer in a nonwoven layer, the present nonwoven fabrics have good wettability by the electrolyte solution, but, because of the inexpensive biopolymers, are nevertheless less expensive than the conventional high-grade nonwoven materials consisting of polyimide that have already been mentioned above. Thus, the advantageous properties of the biopolymers and the polar synthetic polymers are combined in a single nonwoven layer. Separators of the invention may include just one nonwoven layer or else a sequence of two or more nonwoven layers.

More particularly, the surface tension of the first fibers including the biopolymer may be at least as high as the surface tension of the second fibers.

Further preferably, the second fiber has a shrinkage capacity at 130° C. of not more than 2%, preferably not more than 1%. The shrinkage capacity can be determined by heating a rectangular sample of a nonwoven fabric composed of the polymer material of the fibers in DIN A4 format and determining the difference in length thereof before and after heating to 130° C. under air for 1 h, for example by means of a ruler. Separators having such second fibers surprisingly have similar mechanical properties to the conventional costly separators based on polyimides, but are still cheaper because of the additional first fibers including the biopolymers.

Moreover, the biopolymer for the first fibers may be selected from cellulose, polylactide (polylactic acid), polyhydroxybutyrate, chitin, starch and combinations thereof. Biopolymers of this kind likewise have high surface tensions of about 48 mN/m for cellulose and 40-44 mN/m for polylactic acid.

Derivatives of biopolymers which may be used are, for example, what are called regenerate fibers which are produced from renewable raw materials, particularly from cellulose. These biopolymers may, for example, be viscose, which is obtained from pure cellulose, modal, which is produced by a modified viscose process, lyocell, which is produced by use of a wet spinning process, using N-methylmorpholine N-oxide monohydrate as solvent, and cupro, which is produced by the copper oxide-ammonia process.

Further derivatives of biopolymers are acetate fibers (cellulose acetate). These are spun in a dry spinning process from cellulose acetate dissolved in acetone.

Biopolymers of this kind can be converted, for example by melt or solution spinning processes, to fibers which may, for example, also have particularly low thicknesses of <1 μm. In addition, these biopolymers are sufficiently polar and have an adequate surface tension of at least 39 mN/m, preferably at least 42 mN/m, such that they can be wetted efficiently by the polar nonaqueous solvents of the electrolyte solutions of the galvanic cell.

The synthetic polymer for the second fibers may especially be selected from polyamides, polyimides, polyesters, and any desired combinations of these groups of synthetic polymers mentioned. The polyamides (PA) may include, for example, aromatic polyamides (aramids), e.g. poly(p-phenyleneterephthalamides) (PPTA) and aliphatic polyamides, the polyesters, for example polyethylene terephthalate (PET) or polyethylene naphthalate (PEN). The aramids in particular have high thermal and mechanical stability.

Synthetic polymers of this kind have adequate surface tension and excellent mechanical stability, and also a low shrinkage capacity at 130° C., and are therefore of particularly good suitability for forming mechanically stable nonwoven materials having good wettability by the electrolyte in combination with the biopolymers for the first fibers. These synthetic polymers are especially more mechanically stable than polyolefins and can likewise be formed to fibers by way of conventional spinning processes, for example wet and dry spinning processes. In addition, synthetic polymers of this kind also have high surface tensions because of their high polarity. For example, polyimides have surface tensions of about 46 mN/m. Nylon, as an example of a polyamide, has a surface tension of 41.4 mN/m, and PET has a surface tension of 40.9 mN/m.

By combination of biopolymers of different surface tension with fibers of a synthetic polymer having a different surface tension, it is possible to adjust the surface tension of the nonwoven materials of the invention in a particularly simple manner. In that case, this may especially be at least 39 mN/m, further preferably at least 42 mN/m, since the wettability by the electrolyte is particularly good in that case.

In the case of separators of the invention, in a further embodiment of the invention, the thickness of the first fibers of the biopolymer may be different from the thickness of the second fibers of the synthetic polymer. For example, the thickness of the first fibers of the biopolymer may be <1 μm, while the synthetic polymer fibers, for example polyamide (nylon), may have a thickness of <10 μm. Through these different thicknesses, by skillful combination of the fibers of the biopolymer with the second fibers of the synthetic polymer, it is possible to adjust the porosity of separators of the invention in a particularly simple manner. With otherwise constant parameters of the fibers, the porosity decreases with a higher proportion of thicker fibers, whereas it increases with a rising proportion of fibers that are thinner.

In a further embodiment of the invention, the porosity of the separators may be between 20% and 75%, preferably between 30% and 70%. Such values ensure, on the one hand, that electrolyte solution can collect in the pores in a particularly simple manner, such that there is ion conductivity through the separator, but ensure high mechanical stability on the other hand. Thus, possible lithium dendrites which can grow proceeding from the anode in the case of lithium anodes are unable to puncture the separator. The porosity of the separators can be determined, for example, by the measurement of the air permeability of the separators with a Gurley densometer by methods known to those skilled in the art, for example according to ANSI T460 (American National Standards Institute).

In a further embodiment of a separator of the invention, the latter has “labyrinth porosity”, where the thickness of the separator is less than the mean free path length of the ions of the electrolyte solution through the separator. The advantage of such separators is that the formation of lithium dendrites is reduced or ruled out. Separators having labyrinth porosity can be produced, for example, by packing the fibers in the course of production of the nonwoven fabric so tightly that no openings are present in the nonwoven material.

In a particularly advantageous embodiment of a separator of the invention, the first fiber comprises or has been manufactured from cellulose and the second fiber comprises polymide as synthetic polymer or has been manufactured from polyimide. A combination of these two polymers ensures, in a particularly simple manner, that the separator of the invention is mechanically stable and puncture-resistant, but has good wettability by the electrolyte solution because of the good surface tension. Furthermore, such a separator can also be produced less expensively than conventional separators consisting completely of polyimide.

In this case, more particularly, the proportion of cellulose as biopolymer may be between 30% and 60% by volume and, analogously, the proportion of the polyimide may be between 40% and 70% by volume. A particularly preferred embodiment of a separator of the invention consists of 50% by volume of cellulose and 50% by volume of polyimide.

In a further embodiment of a separator of the invention, it is possible to use more than one biopolymer for the first fiber and/or more than one synthetic polymer for the second fiber. Through use of two or more biopolymers and/or two or more synthetic polymers, it is possible to even more accurately adjust the relevant technical parameters of the separator, for example porosity and surface tension.

The present invention further provides a galvanic cell, for example a battery or an accumulator, comprising an anode and cathode, and also an electrolyte and a separator of the invention as described above arranged between the anode and cathode. Such a galvanic cell is cheaper than conventional cells because of the inexpensive separator, but nevertheless has excellent electrical parameters because of the good wettability of the separator of the invention and the mechanical and thermal stability thereof.

More particularly, the separators of the invention can be used for lithium ion accumulators and lithium ion batteries, wherein the anode comprises lithium or graphite and the cathode comprises lithiated transition metal oxides (e.g. cobalt or nickel) or lithiated olivines or a lithiated spinel. The anode may especially include materials that can intercalate and deintercalate lithium ions in a particularly simple manner, for example graphite or nanocrystalline amorphous silicon, or else may comprise or consist directly of lithium metal. The cathode may comprise, for example, LiCoO₂, LiNiO₂, LiFePO₄ or LiMn₂O₄.

In addition, it is possible because of the high mechanical stability of the separators of the invention that the anode, for example, consists of or comprises lithium metal as well. Because of the high puncture resistance of the separators of the invention, possible lithium dendrites which can form in the case of a lithium anode cannot puncture the separator and hence cause a short circuit.

Electrolytes used may, for example, be conducted lithium ion salts such as lithium hexafluorophosphate LiPF₆ and lithium tetrafluoroborate LiBF₄, and solvents used may be aprotic polar solvents, for example ethylene carbonate, propylene carbonate, dimethyl carbonate or, for example, diethyl carbonate.

The present invention further provides a battery containing at least two galvanic cells as already described above that are electrically connected to one another. This can be achieved, for example, by way of an electrical parallel or series connection. Batteries of this kind, for example lithium ion battery, because of their high energy density, can also be used in a particularly advantageous manner as power supply in motor vehicles, for example electric cars.

It is advantageously also possible to use batteries of the invention in mobile devices, especially also mobile end user devices, for example notebooks, mobile phones or tablet PCs in the consumer sector.

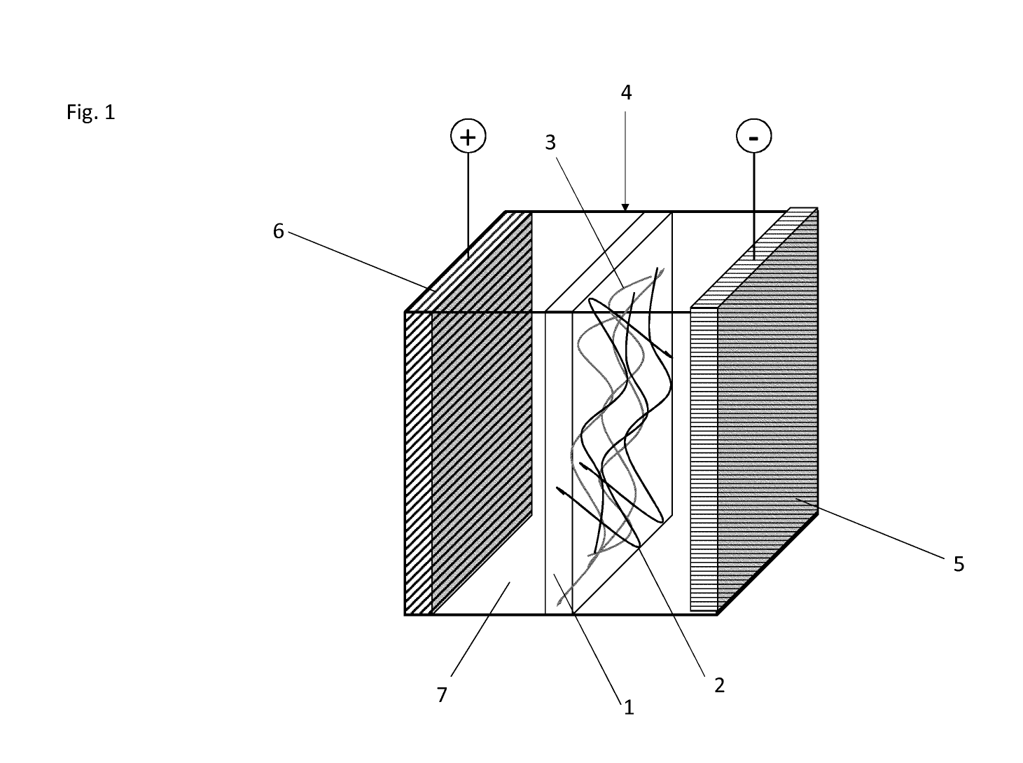

A detailed elucidation of a working example of a galvanic cell of the invention, a lithium ion accumulator, is described with reference to FIG. 1. FIG. 1 shows, in schematic form, a lithium ion accumulator 4 having an anode electrode 5 and an opposite cathode electrode 6. Between the electrodes is arranged a separator 1 having a nonwoven fabric layer in which first fibers 2, indicated as black fiber bundles, and second fibers 3, indicated as gray fiber bundles, are present as intermeshing fibers with statistical distribution. The separator 1 simultaneously also absorbs the nonaqueous, aprotic and polar electrolyte solution 7 which ionically connects the two electrodes 5 and 6 to one another and is present between the electrodes. Such a lithium ion accumulator, because of the separator of the invention, has elevated mechanical and thermal stability and, because of the better wettability of the separator, improved electrical parameters with respect to accumulators having polyethylene or polypropylene as the separator as well. In addition, it is less expensive to produce than accumulators comprising high-grade polar synthetic polymers as separators.

The invention is not restricted by the description with reference to the working examples. Instead, the invention encompasses every new feature and every combination of features, which especially includes every combination of features in the claims even if this feature or this combination itself is not explicitly specified in the claims or working examples.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A separator for a galvanic cell, comprising:
a nonwoven fabric having at least one nonwoven fabric layer, comprising at least one first and one second fiber,
wherein the first fiber comprises or has been manufactured from a biopolymer and the second fiber comprises or has been manufactured from a synthetic polymer having a surface tension of at least 30 mN/m.

2. The separator according to claim 1, wherein the second fiber has a surface tension of at least 36 mN/m

3. The separator according to claim 1, wherein the second fiber has a shrinkage capacity at 130° C. of not more than 0.2 mm.

4. The separator according to claim 3, wherein the second fiber has a shrinkage capacity at 130° C. of not more than 0.01 mm.

5. The separator according to claim 1, wherein the biopolymer for the first fiber is selected from a group consisting of:
cellulose, polylactide, polyhydroxybutyrate, chitin, starch and combinations thereof.

6. The separator according to claim 1, wherein the synthetic polymer for the second fiber is selected from a group consisting of:
polyamide, polyimide, polyester and combinations thereof.

7. The separator according to claim 1, wherein the separator has a surface tension of at least 39 mN/m.

8. The separator according to claim 1, wherein a thickness of the first fiber of the biopolymer is different from a thickness of the second fiber of the synthetic polymer.

9. The separator according to claim 8, wherein the thickness of the first fiber of the biopolymer is <100 μm.

10. The separator according to claim 8, wherein the thickness of the first fiber of the biopolymer is <10 μm

11. The separator according to claim 8, wherein the thickness of the first fiber of the biopolymer is <1 μm.

12. The separator according to claim 1, wherein the separator has a porosity between 20% and 75%.

13. The separator according to claim 1, wherein the separator has a porosity between 30% and 70%.

14. The separator according to claim 1, wherein the first fiber comprises cellulose as the biopolymer.

15. The separator according to claim 1, wherein the second fiber comprises polyimide as the synthetic polymer.

16. A galvanic cell, comprising:
an anode;
a cathode;
an electrolyte; and
a separator arranged between the anode and the cathode, wherein the separator comprises:
a nonwoven fabric having at least one nonwoven fabric layer, comprising at least one first and one second fiber,
wherein the first fiber comprises or has been manufactured from a biopolymer and the second fiber comprises or has been manufactured from a synthetic polymer having a surface tension of at least 30 mN/m.

17. The galvanic cell according to claim 16, wherein the galvanic cell forms a lithium ion accumulator in which the anode comprises lithium and the cathode comprises a lithium ion oxide.

18. The galvanic cell according to claim 17, wherein the anode comprises lithium metal and wherein the electrolyte comprises a lithium ion conductive salt and a non-aqueous polar solvent.

19. A battery comprising at least two galvanic cells according to claim 16, the two galvanic cells being electrically connected to one another.

20. A motor vehicle comprising a battery according to claim 19.
